(19) United States
(12) Patent Application Publication
(10) Pub. No.: US 2023/0166830 A1
(43) Pub. Date: Jun. 1, 2023

(54) HEAT SHIELD COMPRISING A MAIN COMPONENT AND AT LEAST ONE SECONDARY COMPONENT, IN PARTICULAR FOR A PART OF AN AIRCRAFT

(71) Applicant: AIRBUS OPERATIONS (SAS), Toulouse (FR)

(72) Inventors: Alexandre BELLANGER, Toulouse (FR); Arnaud TONNELE, Toulouse (FR)

(21) Appl. No.: 18/071,373

(22) Filed: Nov. 29, 2022

(30) Foreign Application Priority Data
Nov. 30, 2021 (FR) 2112698

(51) Int. Cl. B64C 1/40

(52) U.S. Cl. CPC B64C 1/403

(57) ABSTRACT

A heat shield including a main component and at least one secondary component for a part of an aircraft are disclosed including a main component adhesively bonded to the part and at least one secondary component secured removably to the main component. The main component and the secondary component are made from at least one material that simultaneously provides thermal protection and fire protection, therefore making it possible to obtain a heat shield that is particularly effective and includes at least one removable secondary component allowing access.

### CROSS REFERENCE TO RELATED APPLICATION

This application claims priority to and incorporates by reference the entirety of French Application Number FR 2112698, filed Nov. 30, 2021.

### BACKGROUND

The present invention relates to a heat shield, in particular for a part of an aircraft.

Although not exclusively, the present invention applies more particularly to the creation of a heat shield in the region of a fuel tank of an aircraft. It is known that certain aircraft, such as, in particular, transport airplanes, have tanks situated in a part of the fuselage of the aircraft, into which the fuel is directly introduced. By way of illustration, this may be a rear central tank of a transport airplane.

In this case, the structure of the aircraft needs to comply with very strict conditions in the event of fire outside the aircraft; in particular, the fire must not pass through the structure of the aircraft and the temperature at the internal surface of the fuselage must not exceed a predetermined temperature, generally around 200° C.

A part of the fuselage is generally protected by a belly fairing. However, this belly fairing does not, in general, completely cover the external part of the fuselage in the region of the tank and it does not allow access to the interior of the fuselage.

There is therefore a need for a solution that makes it possible to confer protection on a part of the fuselage of an aircraft, in particular in the region of a fuel tank, which is able to comply with the required conditions mentioned above.

### SUMMARY

The present invention relates to a heat shield, in particular for a part of an aircraft, and in particular a part of the fuselage of the aircraft in the region of a fuel tank, making it possible to meet this need.

To this end, according to the invention, the heat shield has a main component configured to be able to be adhesively bonded and at least one secondary component which is secured, removably, to the main component, and the main component and the secondary component are made from at least one material that simultaneously provides thermal protection and fire protection.

In an exemplary embodiment, the heat shield has a plurality of secondary components secured, removably, to the main component.

Thus, by virtue of the invention, and as specified further below, a heat shield is obtained which simultaneously provides thermal protection and fire protection, specifically for its different components (the main component and the secondary component or components) as is required in the envisioned applications. Moreover, by virtue of the secondary component or components being secured removably, an opening can be created in the heat shield by detaching the secondary component or components, in particular for accessing the interior of the part provided with the heat shield, in particular a part of an aircraft, for example for carrying out a maintenance or repair operation.

The heat shield also has further advantages that are set out below.

Advantageously, the main component is provided with at least one orifice at which the secondary component is arranged.

In an exemplary embodiment, at least one of the main and secondary components has a general structure with a shape adapted to particular elements, external to the heat shield.

Moreover, advantageously, the secondary component is secured to the main component via bolts joined only to the secondary and main components.

Furthermore, advantageously, the heat shield has at least one access hatch.

The present invention also relates to an aircraft part, in particular a part of the fuselage of the aircraft, notably in the region of a fuel tank of the aircraft, which has at least one heat shield such as the one described above, which is adhesively bonded to the part of the aircraft. The protection conferred on the protected part by the heat shield is not reduced by the shield being fixed by adhesive bonding, because adhesive bonding does not create through-openings likely to weaken the effectiveness of the protection.

Moreover, advantageously, the aircraft part comprises at least one zone to be protected, and the heat shield has a surface and is adhesively bonded to the aircraft part so as to completely cover and extend beyond the zone to be protected.

In an exemplary embodiment, the heat shield is likewise fixed, around its periphery, to the aircraft part outside the zone to be protected, via fixing elements that pass all the way through, creating additional fixing.

The present invention also relates to an aircraft, in particular a transport airplane. According to the invention, the aircraft has at least one heat shield such as the one described above, and/or at least one aircraft part such as the one described above.

### BRIEF DESCRIPTION OF THE DRAWINGS

For an understanding of embodiments of the disclosure, reference is now made to the following description taken in conjunction with the accompanying drawings.

FIG. 1 is a schematic side view of an aircraft provided with a heat shield.

FIG. 2 is an enlarged, perspective, schematic, and partial view of a part of the aircraft in FIG. 1, which is provided with the heat shield.

FIG. 3 is a schematic, plan view of an exemplary embodiment of a heat shield.

FIG. 4 is a schematic, plan view of a main component of the heat shield in FIG. 3.

FIG. 5 is a schematic, plan view of an exemplary embodiment of a heat shield.

FIG. 6 is a partial, cross-sectional view of a part of an aircraft fuselage, provided with a heat shield.

### DETAILED DESCRIPTION

Some embodiments will now be described with reference to the Figures.

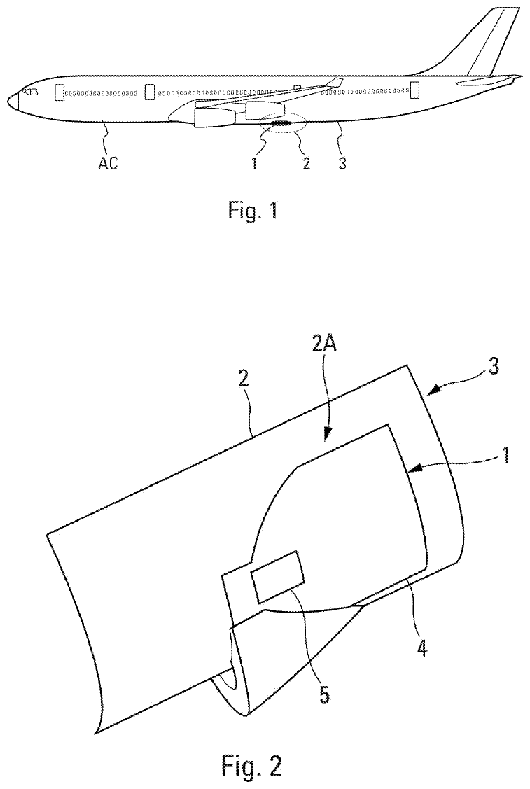

The heat shield 1 which is shown schematically in one exemplary embodiment in FIGS. 2 to 4 and illustrates the claimed subject matter is intended to be mounted on a structural part 2 to be protected at least partially as specified above. Preferably, this part 2 is a part of an aircraft AC, in particular of a transport airplane, as shown in FIG. 1.

In an exemplary but nonlimiting embodiment, the part 2 of the aircraft AC (encircled in FIG. 1 and shown in perspective in FIG. 2), which is intended to receive the heat shield 1, is a part of the fuselage 3 of the aircraft AC, in particular in the region of a fuel tank (not shown).

The part of the aircraft AC that is intended to receive the heat shield 1 may correspond to any part of the aircraft AC that needs to be particularly protected against fire and heat, while allowing access. The heat shield 1 may also be applied to a structural part of a system or machine (in particular a mobile machine) other than an aircraft.

The heat shield 1 comprises a main component 4. This main component 4 is made from a material that simultaneously provides thermal protection and fire protection, as specified below.

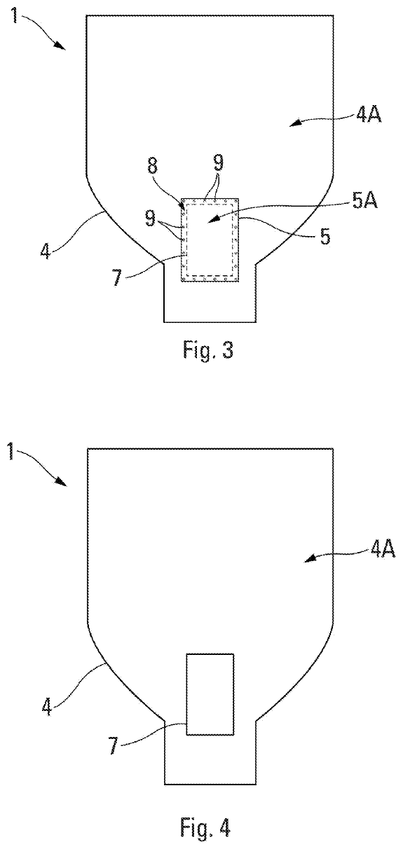

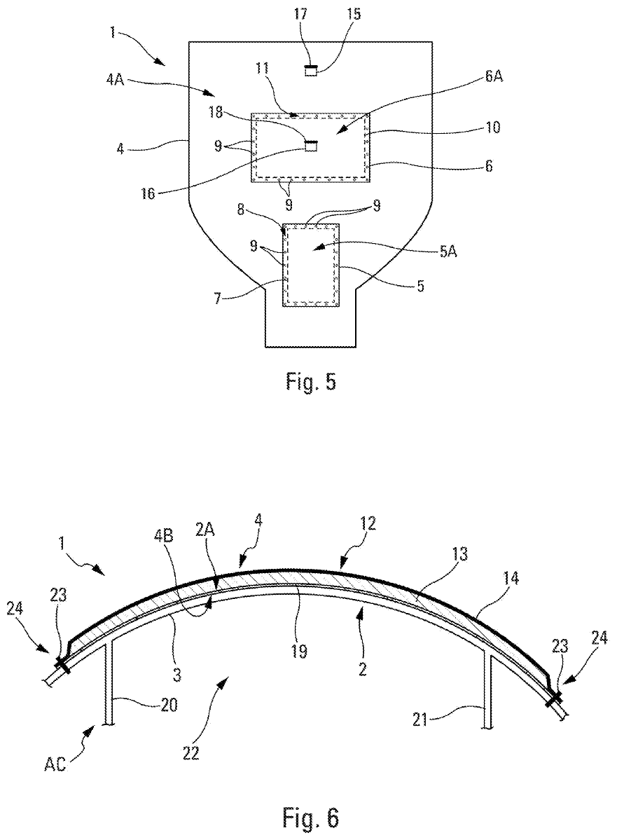

The heat shield 1 also comprises at least one secondary component 5, 6. In the context of the claimed subject matter, the heat shield 1 may comprise:
a single secondary component 5, as shown in the embodiment in FIGS. 2 and 3; or
a plurality of secondary components 5, 6, as shown in the embodiment in FIG. 5.

Each of the secondary components 5 and 6 of the heat shield 1 is secured, removably, to the main component 4. Each of these secondary components 5 and 6 is likewise made from a material that simultaneously provides thermal protection and fire protection.

In the context of the claimed subject matter:
thermal protection means protection that makes it possible to ensure that the temperature at a surface (facing away from the one subjected to a heat source) of the part 2 to be protected does not exceed a predetermined temperature, for example around 200° C.; and
fire protection means protection that makes it possible to prevent fire from passing through the part 2 (provided with the heat shield 1).

Consequently, a heat shield 1 is obtained which simultaneously provides thermal protection and fire protection, specifically for all of its different components (the main component 4 and the secondary component or components 5, 6).

In addition, by virtue of the secondary component or components 5, 6 being secured removably (meaning that it/they can be taken off), a (through-)opening can be created in the heat shield 1 by detaching the secondary component or components 5, 6. Such an opening makes it possible to access the interior of the part 2 provided with the heat shield 1, in particular a part of an aircraft, for example for a maintenance operation.

As shown in FIG. 4, which shows only the main component 4, the latter is provided with an orifice 7, at which the secondary component 5 is arranged so as to obtain the heat shield 1 according to the embodiment in FIG. 3.

The secondary component 5 has a surface which completely covers the orifice 7 and extends beyond the orifice 7 (located by way of dashes in FIG. 3) with a so-called peripheral zone 8 in the form of a rectangular ring.

Preferably, the orifice 7 and the secondary component 5 intended to cover this orifice 7 have an identical shape, for example a quadrilateral shape as in the embodiment in FIGS. 3 and 4, but with different sizes. Of course, any type of shape is conceivable.

The secondary component 5 is secured to the main component 4 in the peripheral zone 8.

This securing is realized by securing elements 9 such as bolts, meaning screw and nut assemblies. The bolts have the advantage of being able to be removed easily in order to separate the secondary component 5 from the main component 4 if necessary. Preferably, this securing is realized only at successive points forming for example a rectangular contour in the peripheral zone 8, as shown in FIG. 3. In addition, each securing element 9 is carried only by the heat shield 1, i.e. is joined only to the secondary component 5 and to the main component 4, and not to the fuselage of the aircraft, thereby making it possible to avoid heat transmission into the fuselage via the securing elements 9.

Furthermore, in the embodiment in FIG. 5, the heat shield 1 has two secondary components 5 and 6. It could, of course, comprise more than two secondary components. In this particular example, the secondary component 5 is similar to the secondary component in FIG. 3.

As for the secondary component 6, this has a surface which completely covers an orifice 10 in the main component 4 and extends beyond the orifice 10 (located by way of dashes in FIG. 5) with a so-called peripheral zone 11 in the form of a rectangular ring.

The secondary component 6 is secured, removably, to the main component 4 in the peripheral zone 11. It is likewise secured removably by securing elements 9 such as bolts. Preferably, this securing is realized only at successive points forming for example a rectangular line in the peripheral zone 11. In addition, each securing element 9 is carried only by the heat shield 1, i.e. is joined only to the secondary component 6 and to the main component 4, and not to the fuselage of the aircraft, thereby making it possible to avoid heat transmission into the fuselage via the securing elements 9.

By virtue of the secondary component or components 5, 6 being secured removably, an opening can be created in the heat shield 1 following detachment of the secondary component or components 5, 6, in particular in order to gain access through the corresponding orifice 7, 10 to the interior of the part 2 (in particular of the aircraft AC) provided with the heat shield 1.

Since the detachment operation makes it necessary, in particular, to withdraw the securing elements 9 (that is to say to take off the bolts in the exemplary embodiment, in which the securing elements 9 are bolts) and to remove the secondary component 5, 6 and is followed by a reinstallation step, it is intended to be implemented only occasionally, for example in order to carry out a repair or maintenance.

In the context of the claimed subject matter, the material (or the protective structure), for example a composite material, which provides thermal protection and fire protection and is used to obtain the main component 4 and/or the secondary component or components 5 and 6, can be realized in different conventional ways.

In an exemplary embodiment, shown in FIG. 6, the main part 4 of the heat shield 1 has a protective structure 12 provided with a layer of foam 13, for example made of silicone. The layer of foam 13 is configured to provide thermal protection. The protective structure 12 also has a skin 14 configured to provide at least fire protection, which is arranged toward the external face which is liable to be subject to a fire. This skin 14 may be made of different materials and, in particular, correspond to a composite panel comprising for example glass, carbon, ceramic and/or titanium or a combination of ceramic and glass or of ceramic and carbon-based material. In a variant, an air gap may also be provided instead of the layer of foam.

Furthermore, in an exemplary embodiment (not shown), the material (or the protective structure) has a stack of superposed layers, these layers being able to simultaneously provide thermal protection and fire protection. These superposed layers are, for example, made of ceramic.

Furthermore, in an exemplary embodiment:
the main component 4 has a general structure 4A with a shape adapted to particular elements, external to the heat shield 1, which are located in the region of the part 2; and/or
the secondary component 5 has a general structure 5A with a shape adapted to particular elements; and/or
the secondary component 6 has a general structure 6A with a shape adapted to particular elements.

A general structure with an adapted shape is understood to mean that the general structure (or the overall shape) 4A, 5A, 6A, in particular in cross section, of the plate forming the main component 4 or the secondary component 5, 6 in question has a shape, for example partially domed or provided with grooves or ridges, which is configured to adapt to particular elements, for example cables or systems, which are not part of the heat shield 1 and are located in the region of the part 2. In particular, these may be conventional elements that are installed inside the aircraft and in particular, in the application to a fuel tank, conventional elements that are installed inside the fuel tank.

Furthermore, in an exemplary embodiment, the heat shield 1 also has at least one access hatch 15, 16, as shown in FIG. 5. Such an access hatch 15, 16, of reduced size, for example for allowing visual inspection or regular maintenance, is optional.

In the example in FIG. 5, the heat shield 1 has an access hatch 15 which is installed in the main component 4. This access hatch 15 is arranged at an orifice (not shown) made in the main component 4. The access hatch 15 is provided with a hinge 17 and with conventional locking/unlocking means (not shown), which make it possible to open and close the access hatch 15 by pivoting it.

In addition, in the example in FIG. 5, the heat shield 1 also has an access hatch 16 which is installed in the secondary component 6. This access hatch 16 is arranged at an orifice (not shown) made in the secondary component 6. The access hatch 16 is provided with a hinge 18 and with conventional locking/unlocking means (not shown), which make it possible to open and close the access hatch 16 by pivoting it.

Opening one of the access hatches 15, 16 makes it possible gain access through the corresponding orifice to the interior of the (main or secondary) component in question, for example for sensor checking operations or for reading measurements or the gauge state. The access hatches 15,16 may, for example, be made from a graphite-, carbon- or glass-fiber reinforced plastic.

The heat shield 1 may have one or more access hatches, provided, depending on the embodiment in question, in the main component 4 and/or in one or more of the secondary components 5, 6, depending in particular on the need for it to be possible to make checks, in particular visual checks.

The main component 4 of the heat shield 1 is fixed by adhesive bonding of a so-called internal face 4B to the external face 2A of the part 2 of the aircraft AC. In the example in FIG. 6, the main component 4 of the heat shield 1 is fixed to the external face 2A with the aid of an adhesive 19, for example a silicone mastic, a so-called sealant mastic, or an epoxy-based adhesive. Preferably, the adhesive 19 is applied to the entire surface of the internal face 4B of the main component 4 of the heat shield 1. In an exemplary embodiment, it is also conceivable to provide the adhesive bonding only on one or more zones of the internal face 4B of the main component 4 and not on the entire surface of this internal face 4B.

Fixing by adhesive bonding has the advantage of not reducing the thermal protection created by the heat shield 1. This is because it avoids, in particular, the use of fixing elements such as rivets or screws which pass all the way through and conduct heat, and which would reduce the thermal protection properties if they were used for fixing purposes.

In an exemplary embodiment, the main component 4 of the heat shield 1 is only fixed by adhesive bonding, with the aid of adhesive 19, to the external face 2A of the part 2.

Moreover, in an exemplary embodiment shown in FIG. 6, in addition to adhesive bonding (as is implemented in the exemplary embodiment) with the aid of adhesive 19, additional fixing of the main component 4 is provided. This additional fixing may be realized, for example, by fixing elements 23 such as, preferably, rivets (or bolts). Preferably, this fixing is only realized at successive fixing points situated along a line provided close to the peripheral edge of the main component 4.

In addition, in an exemplary embodiment, as shown in FIG. 6, the main component 4 of the heat shield 1 has a surface which completely covers the part to be protected (specified below) and extends beyond this part to be protected with a so-called peripheral zone 24, and the additional fixing is realized in this peripheral zone 24.

This additional fixing makes it possible to always keep the heat shield 1 secured to the part 2, in particular if, for some reason, the adhesive bonding loses its effectiveness.

As indicated above, in a preferred but nonlimiting application, the part 2 of the aircraft AC that receives the heat shield 1 is a part of the fuselage 3 of the aircraft AC in the region of the fuel tank 22 as shown in FIG. 6, and in particular a part 2 of the fuselage 3 that is not protected by a belly fairing. If necessary, the heat shield may be adhesively bonded at at least one of its ends to a belly fairing (not shown).

In such an application to a fuel tank 22, for example a rear central tank of a transport airplane, one of the secondary components 5 and 6 (not shown) of the heat shield 1 may be positioned so as to allow access to a pumping system of the fuel tank 22 or to a cable routing, in particular for (infrequent) maintenance or repair operations, for example for replacing the pumping system or cables.

FIG. 6 partially shows side walls 20 and 21 of the fuel tank 22, the fuel tank 22 being situated between these side walls 20 and 21. In this example, the shield 1 has a surface which completely covers the part to be protected, namely the part of the fuselage 3 between the side walls 20 and 21, and which extends beyond this part to be protected, toward the outside of the fuel tank 22 and therefore the side walls 20 and 21, in the peripheral zone 24. The additional fixing is realized in this peripheral zone 24 with the aid of the fixing elements 23 that pass all the way through. These fixing elements 23 that pass all the way through and are liable to weaken the thermal protection are therefore situated outside the zone to be protected.

In the context of the present invention, the part of the aircraft AC that is intended to receive the heat shield 1 may correspond to any part of the aircraft AC that needs to be particularly protected against fire and heat. Furthermore, the heat shield 1 may also be applied to a part of a system or of a machine other than an aircraft, which requires such protection, while allowing access.

While at least one exemplary embodiment is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A heat shield for a part of an aircraft, comprising:
a main component configured to be adhesively bonded, the main component being made from at least one material that simultaneously provides thermal protection and fire protection,
wherein the heat shield has at least one secondary component which is secured, removably, to the main component,
wherein the main component is provided with at least one orifice at which the secondary component is arranged, and
wherein the second component is made from a material that simultaneously provides thermal protection and fire protection.

2. The heat shield as claimed in claim 1, wherein the secondary component has a surface that completely covers the orifice and which extends beyond the orifice with a peripheral zone.

3. The heat shield as claimed in claim 1, wherein at least one of the main and secondary components has a general structure with a shape adapted to particular elements.

4. The heat shield as claimed in claim 1, wherein the secondary component is secured to the main component via bolts joined only to the secondary and main components.

5. The heat shield as claimed in claim 1, further comprising a plurality of secondary components secured, removably, to the main component.

6. The heat shield as claimed in claim 1, further comprising at least one access hatch.

7. An aircraft part in a region of a fuel tank, comprising at least one heat shield as claimed in claim 1, wherein the at least one heat shield is adhesively bonded to the aircraft part.

8. The aircraft part as claimed in claim 7, further comprising at least one zone to be protected, and wherein the heat shield has a surface and is adhesively bonded to the part so as to completely cover and extend beyond the zone to be protected.

9. The aircraft part as claimed in claim 8, wherein the heat shield is fixed, around its periphery, to the part outside the zone to be protected, via fixing elements that pass all the way through.

10. An aircraft, comprising at least one heat shield as claimed in claim 1

11. An aircraft, comprising at least one part of an aircraft as claimed in claim 7.
